(19) United States
(12) Patent Application Publication
(10) Pub. No.: US 2003/0041008 A1
(43) Pub. Date: Feb. 27, 2003

(54) System and method for facilitating transactions among disparate entities

(76) Inventors: William Grey, Millwood, NY (US); Stuart I. Feldman, Stamford, CT (US); Manoj Kumar, Yorkttown Heights, NY (US); Dailun H. Shi, Croton on Hudson, NY (US); Frederick Yung-Fung Wu, Cos Cob, CT (US); Brian T. Eck, Poughquag, NY (US); Brenda L. Dietrich, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 09/934,617

(22) Filed: Aug. 22, 2001

(51) Int. Cl. G06F 17/60

(52) U.S. Cl. 705/37

(57) ABSTRACT

An auction is conducted by receiving, from a participant, a request for an item. An auction for the item is identified and a bid for the item is received from the participant. The received bid is forwarded to an auction for the item. In some embodiments, a transformation function associated with the participant is identified and applied to the bid to produce a transformed bid. The transformation function reflects different information about participants, the items, or the auctions (e.g, participants from different industries or from different countries).

### CROSS-REFERENCE TO RELATED APPLICATIONS

This application is related to the following co-pending and commonly assigned U.S. Patent Applications (the content of each of which is hereby incorporated by reference herein for all purposes):

U.S. patent application Ser. No. ______ , filed ______(on even date herewith) for “SYSTEM AND METHOD FOR PERSONALIZED DYNAMIC PRICING” (Attorney Docket No. 101.50 and Client Docket No. YOR920010388US1);

U.S. patent application Ser. No. ______, filed ______(on even date herewith) for “SYSTEM AND METHOD FOR CONDUCTING A SELL-SIDE AUCTION” (Attorney Docket No. 101.51 and Client Docket No. YOR920010409US1);

U.S. patent application Ser. No. ______, filed ______(on even date herewith) for “SYSTEM AND METHOD FOR CONDUCTING A BUY-SIDE AUCTION” (Attorney Docket No. 101.52 and Client Docket No. YOR920010410US1);

U.S. patent application Ser. No. ______, filed ______(on even date herewith) for “SYSTEM AND METHOD FOR CONDUCTING A TWO-SIDED AUCTION” (Attorney Docket No. 101.53 and Client Docket No. YOR920010411US1);

U.S. patent application Ser. No. ______, filed ______(on even date herewith) for “SYSTEM AND METHOD FOR ESTABLISHING CUSTOMIZED LEASING TERMS” (Attorney Docket No. 101.54 and Client Docket No. YOR920010412US1); and

U.S. patent application Ser. No. ______, filed ______(on even date herewith) for “SYSTEM AND METHOD FOR BUNDLING GOODS” (Attorney Docket No. 101.56 and Client Docket No. YOR920010414US1).

### FIELD OF THE INVENTION

The present invention generally relates to commerce systems and methods. More particularly, embodiments of the present invention relate to systems and methods for conducting sales of goods and services.

### BACKGROUND OF THE INVENTION

Auctions have proliferated with the advent of the Internet and advances in communication. Many businesses use auctions and marketplaces to buy and sell goods and services and often enjoy great savings and efficiencies as a result. The essential premise of an auction is that prices are determined as a result of competition between bidders for items offered for sale or purchase. These benefits, however, are only realized when more than one bidder is competing for the same item.

A number of different auction styles and types have developed over the years to encourage different types of competitions among bidders, including, for example: English auctions, Dutch auctions, Japanese auctions, sealed-bid auctions, double auctions, multiple-unit auction, time interval auctions, call auctions, first price auctions, uniform second price auctions, bundle auctions, and multi-attribute auctions.

Many of these types of auctions may be conducted as either one or two-sided auctions. One-sided auctions allow only bids or asks (but not both). One-sided auctions may be run as open or sealed-bid auctions, and as forward or reverse auctions. Two-sided (or double) auctions allow both bids and asks to take place at the same time. The term auction as defined herein shall also include exchanges, which are electronic or online marketplaces that facilitate a many-to-many trading relationship among or between buyers and sellers. Exchanges are commonly referred to by a number of names, including a trading hub, a vortex, an online marketplace, butterfly market, a bid-ask, an e-marketplace, an e-market, an ehub, a net market maker, an eMarket, a vertical marketplace, or a horizontal marketplace. The term auction as defined herein shall also include bulletin boards and other online commerce platforms that facilitate or enable one-to-many or many-to-many trading relationships among or between buyers and sellers. These various types of auctions and marketplaces are generally known in the art.

One type of two-sided auction is the “continuous double auction’ where many individual transactions are carried on simultaneously and where trading does not stop when a match occurs. Examples of such auctions are financial or securities exchanges such as intra-day trading on the New York Stock Exchange. Another type of two-sided auction is a call auction, where bids and offers are aggregated, then periodically cleared. Examples of such auctions are the opens at the New York Stock Exchange and periodic calls on the Paris Bourse.

Some auctions and marketplaces are completely automated. In other cases, non-automated entities facilitate, support or otherwise enable marketplace transactions, potentially providing a number of benefits, including increasing market liquidity, and ensuring orderly price movements. For example, “specialists” serve this role on the New York Stock Exchange, and market-makers serve this role on the NASDAQ. As defined herein, auctions include both purely automated marketplaces, and marketplaces in which non-automated entities facilitate, support or otherwise enable marketplace transactions.

A common feature of most of these auctions and marketplaces is that they are generally used to sell or acquire relatively homogeneous goods or services. Without standardization of the goods or services, it is difficult to generate sufficient competition among bidders to achieve the benefits that auctions provide. As a result, auctions are typically not suited for many types of non-standardized goods or services.

Further, auctions are typically not suited for many types of business-to-business environments. Many business-to-business transactions rely on existing relationships between the buyer and the seller. For example, sellers often provide strategic partner discounts to buyers with whom they have a long-standing relationship. Strategic customers expect, and often receive, volume discounts, preferred credit terms, and higher service levels than other customers. Channel partners expect to pay lower prices than their customers. Most existing auctions do not encourage or permit this type of differentiation between participants. Most existing auctions treat all participants as equals. Buyers who purchase in volume pay the same price as buyers who purchase in smaller lots. In fact, buyers who purchase in volume may sometimes pay more than buyers who purchase in smaller lots, since purchases by large buyers may have an impact on the market price of the good or service being transacted, since the size of these purchases results in an imbalance between supply and demand in the market, and may be viewed as a signal regarding future price movements.

Typically, existing auctions treat the bids of strategic, or long-standing customers or suppliers the same as bids from brand new customers or suppliers. It would be desirable to provide an auction and exchange system and method that allows participants to be treated differently, while still allowing these different participants to take part in the same auction.

Existing auctions are also not well-suited to the sale of differentiated or mass-customized products. Such products are often bundled with value-added services or contain a variety of special features and configurations. Items offered for sale or purchase using existing auctions are not typically customizable. Bidders all bid on the same configuration. As a result, because of their specialized nature, items sold at existing auctions may not attract enough interested bidders to generate active bidding. Many buyers and sellers in existing auctions attempt to minimize this problem by compromising and offering standard product configurations. These standard configurations lack differentiation and often sell at lower, commodity prices. Low commodity pricing can lead to price erosion in other channels and for other products, as customers and channel partners in other sales channels begin demanding comparable pricing.

A number of auction mechanisms have attempted to address some of these shortcomings. Multi-attribute auctions and exchanges allow bidders to negotiate over the attributes of an item, as well as its price, thus seeking to address the issue of auctioning differentiated goods and services. However, determining the winner of a multi-attribute auction often requires complex analysis, and is not readily transparent to market participants. This makes it difficult for auction participants to understand the bidding process, and may raise concerns about whether the auction is matching bids and offers in an equitable fashion. In addition, multi-attribute auctions often require bidders to specify the relative value they place on different attributes. In many cases, bidders may not know clearly the relative value they place on different attributes, or may have difficulty specifying it. This also creates difficulties for another reason. In many cases it may not be in the bidders' interest to be completely forthcoming about this information, and thus they may withhold or misrepresent this information. Unfortunately, these misrepresentations can distort the auction results.

Combinatorial auctions and combinatorial exchanges allow bidders to negotiate for bundles of items. Typically, bidders specify the relative importance they place on different bundles of items, and the auction performs an optimization to match bids and offers in a fashion that maximizes the benefit to market participants. Unfortunately, combinatorial auctions and exchanges may suffer from similar drawbacks as multi-attribute auctions. They are complex, making it difficult for auction participants to understand and interpret the bidding process and auction results. In addition, they may require bidders to reveal information that they consider private, and may thus be subject to misrepresentations by auction participants.

Many of these auction challenges and difficulties are exacerbated in auctions involving participants from different industries and/or different countries. Entities which use auctions to sell items to customers in different industry segments often tailor their offerings to address industry-specific requirements for sale terms such as warranty terms, delivery terms, or credit terms. As a result, potential bidders from other industry segments may be discouraged from bidding. As a consequence, auctions have been developed that are specialized to the particular business needs of individual industry segments. While this addresses the needs of different industry participants, it also leads to more fragmented markets that are not as deep or liquid.

Similar difficulties can arise in auctions involving participants from different countries. An auction conducted in the U.S. typically provides auction status and rules in U.S. terms (including U.S. currency, U.S. shipping, U.S. laws and regulations, etc.). An auction conducted in another country, such as Germany, typically provides auction status and rules in terms of that country (including local currency, local shipping requirements, local laws and regulations, etc.). This requires establishing multiple auctions, one for each geographical or political unit. Again, while this addresses the particular needs of different local participants, it leads to more fragmented markets that can lack liquidity or depth.

It would be desirable to provide a system and method that allows participants having different circumstances (e.g., different industry or geographical circumstances or other different characteristics) to participate in the same auction for the same item(s). It would further be desirable to provide a system and method that allows the establishment of different auction treatments for participants having different circumstances (e.g., different industry or geographical circumstances). It would also be desirable to aggregate bidding from multiple auctions into a single “primary” auction representing the composition of multiple sub-auctions.

### SUMMARY OF THE INVENTION

Embodiments of the present invention provide a system, method, apparatus, and computer program code for facilitating the sale of an item in an auction involving a plurality of participants having different characteristics. According to one embodiment of the present invention, an auction is conducted by receiving, from a participant, a request for an item. An auction for the item is identified and a bid for the item is received from the participant. The received bid is forwarded to the identified auction. In some embodiments, a transformation function associated with the participant is identified and applied to the bid to produce a transformed bid. In some embodiments, the auction which is identified is a different auction than the auction which receives the request.

According to some embodiments, a system, method, apparatus and computer program code for conducting an auction includes identifying a bid for a first item in a first auction. A bid for a second item in a second auction is also identified. A common characteristic of the first and second items is identified and an auction is conducted based on the common characteristic.

According to some embodiments, a system, method, apparatus and computer program code for operating a secondary auction includes receiving a request for an item from a participant. A primary auction for the item is identified. Auction information is received from the primary auction and is presented to the participant. A bid for the item is received from the participant. At least a first transformation function is identified and applied to the bid to generate a transformed bid. The transformed bid is submitted to the primary auction.

According to some embodiments, a system, method, apparatus and computer program code for operating a primary auction for an item includes receiving, from a secondary auction, a bid for the item, the bid having been transformed by at least one transformation function associated with an entity submitting the bid. A state of the primary auction is updated based on the received bid.

According to some embodiments, a system, method, apparatus and computer program code for participating in an auction involving a plurality of buyers and at least one seller of an item includes registering to participate as a buyer in the auction, providing information about at least one characteristic, and establishing at least a first transformation function for use in the auction based at least in part on the characteristic.

According to some embodiments, a system, method, apparatus and computer program code for composing a plurality of auctions includes identifying a first bid from a first auction, the first bid transformed by at least a first transformation function, identifying a second bid from a second auction which has been transformed by at least a second transformation function, and comparing the first and second bids to identify a best bid.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system pursuant to embodiments of the present invention;

FIG. 2 is a block diagram of one embodiment of the auction administrator device of FIG. 1;

FIG. 3 is a tabular representation of a portion of a participant database according to an embodiment of the present invention;

FIG. 4 is a tabular representation of a portion of an auction database according to an embodiment of the present invention;

FIG. 5 is a tabular representation of a portion of a transformation function database according to an embodiment of the present invention;

FIG. 6 is a tabular representation of a portion of a bid database according to an embodiment of the present invention;

FIG. 7 is a flow diagram depicting a transformation binding process according to one embodiment of the present invention;

FIG. 8 is a flow diagram depicting a bid process according to one embodiment of the present invention; and

FIG. 9 is a flow diagram depicting a transaction process according to one embodiment of the invention.

### DETAILED DESCRIPTION

Applicants have recognized that there is a need for a system, method, apparatus, and computer program code for facilitating transactions among entities with different characteristics participating in a competitive bidding environment, such as an auction. In particular, Applicants have recognized that the use of one or more transformation functions to transform bids and auction status to personalize the auction experience for multiple differently-situated participants will facilitate competitive bidding between these participants, resulting in overall reduced prices for buyers, and increased demand for sellers. Applicants have further recognized that such transformations may be used to facilitate bidding among participants from different geographical locations, from different industry segments, or differentiated by other participants characteristics.

A number of terms are used herein to describe features of embodiments of the present invention. As used herein, the term “auction” will be used to refer to any of a number of formats (known and to be developed) for selling goods or services in a competitive bidding environment. As used herein, the term “auction” may be used to refer to the set of activities that take place to solicit, receive, analyze, and respond to bids for a particular item or items. A number of different auctions may take place at any given time. Each auction involves the interaction of several entities, including at least one buyer, at least one seller, and an auction administrator. In some embodiments, one or more service providers may be involved in an auction, acting on behalf of one or more buyers, sellers, and/or administrators.

As will be described, embodiments of the present invention may be used with a number of different types of auctions, including, for example, those auctions referred to as: English auctions, Dutch auctions, Japanese auctions, sealed-bid auctions, double auctions, multiple-unit auctions, time interval auctions, call auctions, first price auctions, uniform second price auctions, bundle auctions, combinatorial auctions, and multi-attribute auctions. Embodiments of the present invention may also be used with other types of exchanges and marketplaces known in the art.

As used herein, the term “bid” (or the term “submission”) will be used to refer to an offer to purchase or an offer to sell (depending on the type of auction in which the bid is made) received from an auction participant. For the purposes of this disclosure, the term “bidder” will be used to refer to the party submitting a bid. A buyer or a seller (both of which are defined further below) may be a bidder, depending on the type of auction. A bid may include one or more terms of the bid, such as a price term, a quantity term, a configuration term, a delivery term, or the like. The bid may involve an actual purchase or transfer, a contingent purchase or transfer, the purchase or transfer of certain rights, and other types of commercial and non-commercial transactions known in the art.

As used herein, the term “buyer” may be used to refer to a party submitting a bid (an offer to purchase) on an item in an auction. For example, the buyer may be a prospective buyer, submitting an offer to purchase or acquire an item offered in an auction. For the purposes of this disclosure, the term “buyer” refers to prospective buyers as well as the actual purchasers of item(s) by auction. A buyer could also be a human agent representing a prospective buyer, or an intelligent software agent such as a shopping “bot” representing a prospective buyer.

As used herein, the term “seller” may be used to refer to the party offering to sell or provide an item in an auction. For example, the seller may be a prospective seller, submitting a bid (an offer to sell or distribute) on an item offered in an auction. For the purposes of this disclosure, the term “seller” refers to prospective sellers as well as the actual seller of item(s) by auction. A seller could also be a human agent representing a prospective seller, or an intelligent software agent such as a shopping “bot” representing a prospective seller. Both “buyers” and “sellers” will be referred to as “participants” in the auction.

As used herein, the phrase “winning bid” will be used to refer to a bid (either an offer to purchase, an offer to sell, or either an offer to sell or an offer to purchase, depending on the type of auction) which, at the close of the auction, results in the winning participant acquiring the right (or obligation) to purchase or sell the item offered in the auction. Depending on the type of auction, the “winning bid” may not necessarily be the highest priced bid (e.g., in a Dutch auction, the winning bid may be at a lower price than earlier bids). Depending on the type of the auction, there may be multiple “winning bids”. As used herein, the phrase “current best bid” will be used to refer to any bid which, during the conduct of the auction, would be the “winning bid” if the auction were to close without consideration of further bids.

As used herein, the term “administrator” will be used to refer to an entity operating as the coordinator, organizer or facilitator of an auction or exchange. The administrator may be an independent entity operating a commercial auction or exchange, or the administrator may be operating on behalf of a seller or buyer to conduct a closed or private auction with a limited number of participants. The administrator may also be operating on behalf of a seller or buyer to conduct a public auction with a broad range of participants. In embodiments described herein, the administrator will be described as the entity controlling the resources used to solicit information (e.g., bids, auction status data, and transformation data). In some embodiments, the administrator may be an independent entity. In other embodiments, the administrator may be an affiliate of one or more participants in the auction, and/or an affiliate of one or more service providers. In other embodiments, the administrator may be a participant in the auction, or a service provider, or an entity partially or entirely owned or controlled by one or more participants in the auction, or by one or more service providers.

As used herein, the term “service provider” will be used to refer to an entity that provides value-added services such as logistics support, fulfillment, financing, or transaction settlement services that facilitate conducting transactions in an auction or exchange. The service provider may be an independent entity providing services, an entity operating on behalf of an auction administrator, or an entity operating on behalf of a participant (e.g., a buyer or seller) in an auction. In some embodiments, the service provider may be an entity controlling resources used to solicit information (e.g., information used to develop transformation functions or other information used in conjunction with embodiments of the present invention).

As used herein, the term “item” may be used to refer to any of a number of different types of goods or services that may be purchased or sold in an auction or exchange format. As an illustrative example, items that may be purchased or sold using techniques of the present invention may include: differentiated goods, commodities, factor inputs, components, systems, subsystems, devices, raw materials, manufactured products, services, options to purchase goods or services, financial instruments, claims on assets, contingent claims on assets, or the like. An “item” may be an individual component, device or service. An “item” may also be a grouping of individual components, devices or services (sometimes referred to herein and in the art as a “lot” or as a “bundle”). An “item” may also be an assemblage of components and/or services into a system (sometimes referred to herein and in the art as a “configuration”).

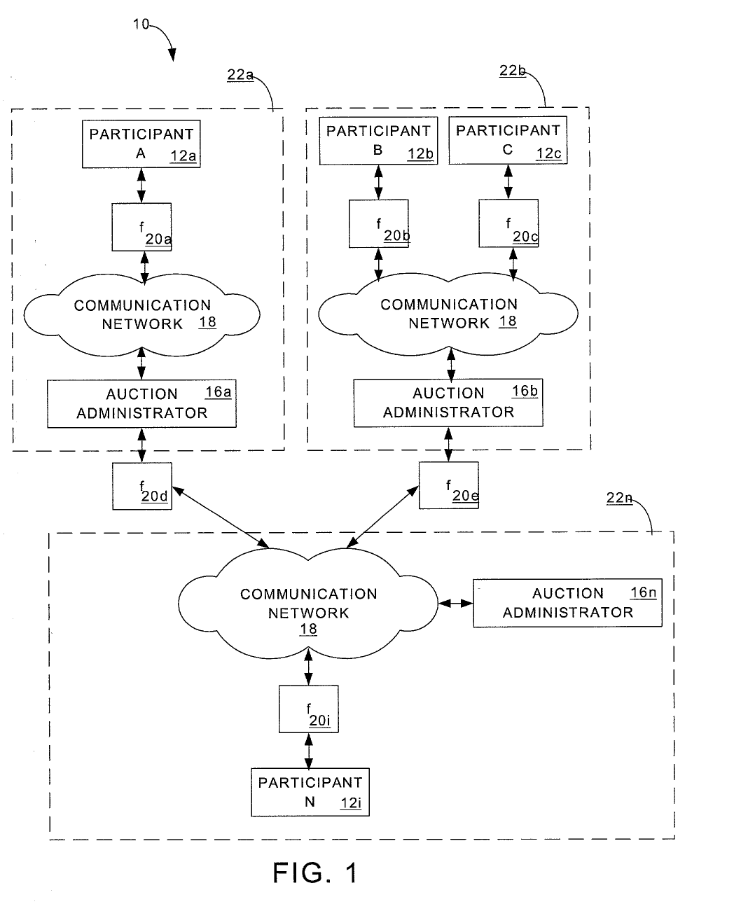

An embodiment of the present invention will now be described by referring to FIG. 1, where an auction system 10 is shown. As shown in FIG. 1, auction system 10 includes a number of participants operating participant devices 12. The participants may include one or more individuals or entities acting as buyers in an auction (and operating buyer devices 12a-i) and who submit offers to purchase items posted for sale or purchase in the auction. The participants also include one or more individuals or entities acting as sellers in an auction (and operating seller devices 12n-z (not shown)) and who submit offers to sell items in an auction. One or more auction administrators operating auction administrator devices 16 may be employed to administer auctions employing features of the present invention. In the embodiment depicted, three different auctions 22a, b, and n are being conducted by three different auction administrator devices 16a, b, and n. In some embodiments, the same auction administrator device 22 may be used to conduct several different auctions 22. Each auction 22 may be conducted using techniques of the present invention and using techniques described in co-pending and commonly-assigned U.S. patent application Ser. Nos. ______, ______, ______, ______, and ______ (Attorney Docket Nos. 101.050, 101.051, 101.052, 101.053, 101.054 and 101.056, respectively) referenced above.

In the embodiment depicted, only several participants are shown for illustrative purposes only. Those skilled in the art will recognize that each auction 22 may involve a number of different participants 12. Other entities (not shown) may also participate in auction system 10. For example, one or more auction service providers operating auction service provider devices may be employed to provide value-added services supporting an auction conducted in auction system 10. Although only three different auctions are shown, those skilled in the art will recognize that any number of auctions may be conducted using techniques of the present invention.

Each of these parties may communicate and participate in auctions pursuant to the invention via one or more communication networks 18. Although three separate communications networks are shown in FIG. 1, those skilled in the art will recognize that the same, or related, communications facilities may be used by the parties. Each of the parties, in one embodiment, operates computing devices in communication with communication network 18. These devices will be described further below. For the purpose of describing features of the invention, the party (e.g., the auction administrator) and the device operated by that party (e.g., an auction administrator computing device) may be referred to as either the party or the device (e.g., “participant 12” may also be referred to as “participant device 12”).

In one embodiment of the present invention, one auction (e.g., auction 22n) is considered the “primary” auction, while other auctions (e.g., auctions 22a-b) which refer bids or status requests to the primary auction are referred to as “secondary” auctions. According to one embodiment of the present invention, participants having different characteristics may competitively bid in a primary auction via one or more secondary auctions. The result is a system which enjoys participation from a wide variety of differently-situated participants. Depending on the item being sold, each auction 22a-n may act as either a “secondary” or “primary” auction. For example, auction 22a may be a “primary” auction for a particular item if the other auctions 22b-n do not currently have an ongoing auction for the item (e.g., bids received by auctions 22b-n for the item will be forwarded to auction 22a).

According to one embodiment of the present invention, each auction 22 is conducted by an auction administrator operating auction administrator device 16 which is configured as a Web-based server device accessible to participants 12 (including participants acting as buyers as well as participants acting as sellers) via the Internet. The auction operated by the auction administrator via auction administrator device 16 may be any of a number of different types. Participation by buyers and sellers will vary based on the type of auction. For example, in a sell-side auction, a plurality of buyers operating buyer devices 12a-i will interact with an auction administrator operating auction administrator device 16 to submit offers to purchase items posted by one or more sellers operating seller devices 12n-z (not shown). In a buy-side auction, a plurality of seller devices 12n-z (not shown) will interact with auction administrator device 16 to present offers to sell items requested by one or more buyers via buyer devices 12a-i. Other auction or exchange types will involve other forms of interaction known in the art.

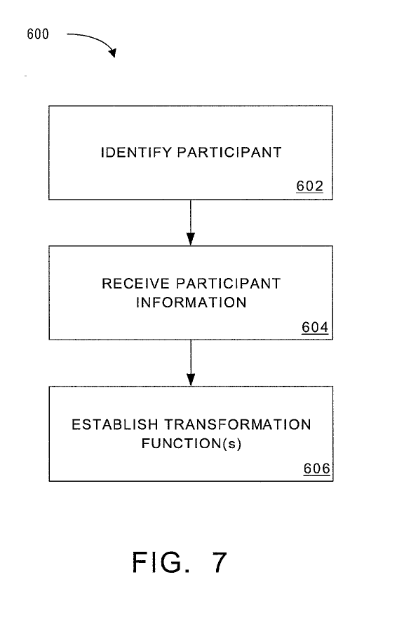

Pursuant to one embodiment of the present invention, one or more participants may be associated with one or more transformation functions 20. As will be described further below, these transformation functions 20 are used to modify, adapt, translate or otherwise transform information used in an auction. In some embodiments, a number of transformation functions 20 may be established for different participants in one or more auctions (e.g., using a transformation binding process such as the process described in conjunction with FIG. 7 below). These transformation functions may be associated with different participants based on different characteristics of each participant. For example, according to some embodiments of the present invention, transformation functions are associated with participants and applied in auctions based on different geographical and/or industry characteristics of the participant. Other transformation functions may also be established, including functions which are established for particular participants or groups of participants. Other types of transformation functions may be established, including transformations, configuration functions, and financing functions as described in co-pending and commonly-assigned U.S. patent application Ser. Nos. ______, ______, ______, ______, and ______ (Attorney Docket Nos. 101.050, 101.051, 101.052, 101.053, 101.054 and 101.056, respectively) referenced above.

As an example, a participant, such as participant 12a, may be associated with a transformation function 20a which transforms some or all of the bids submitted by participant 12a. For example, transformation function 20a may be a transformation that automatically applies information about participant 12a's geographical circumstances to each bid submitted by that participant (e.g., modifying the bid's currency and amount, applying specialized shipping rules, applying specialized export control rules, etc.). Transformation function 20a may also be a transformation that automatically applies information about the participant's industry segment to each bid submitted (e.g., setting forth particular quality requirements, industry-standard compliance, service and delivery requirements, payment requirements, other industry conventions, etc.). Transformation function 20a may also be a transformation that automatically applies information about the participant's auction administrator to each bid submitted (e.g., modifying the bid to reflect charges or fees that the participant's auction administrator charges participants in its auction, modifying the bid to reflect charges or fees of the primary auction's auction administrator, etc.).

Other participants may have different transformation functions associated with them. For example, participant 12b may be associated with a transformation function 20b that automatically applies different transformations to bids submitted by participant 12b in auctions conducted pursuant to embodiments of the present invention (e.g., participant 12b may submit bids with different geographical and/or industry segment requirements). Use of such transformation functions 20 to modify bids submitted by participants allows disparate entities having different characteristics to competitively bid in the same auction. These transformation functions 20 may be associated with participants using a transformation binding process or registration process as described in co-pending applications referenced above.

Transformation functions 20 may also be used to modify, adapt, translate or otherwise transform information that is transmitted between auctions, between auction administrator devices, and between auction administrator devices and participant devices. For example, participant 12a may view the status of the primary auction after the status has been transformed by a transformation function 20d associated with participant 12a. Other types and uses of transformation functions 20 pursuant to the present invention will be discussed further below.

Each of the parties operating devices 12 or 16 may communicate via communication network 18, which may be any of a number of different types of commonly-used networks, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Participant devices 12a-z and auction administrator devices 16a-n may be any devices capable of performing the various functions described herein. In one embodiment, auction administrator devices 16a-n are configured as Web-based server devices, and participant devices 12a-z are configured as general purpose computing devices. In general, participant devices 12 and auction administrator devices 16 may be computing devices such as: a Personal Computer (PC), a portable computing device such as a Personal Digital Assistant (PDA), a wired or wireless telephone, a one-way or two-way pager, a kiosk, an interactive television device, or any other appropriate storage and/or communication device. Other participants (not shown) such as auction service providers may operate similar devices and communicate in similar fashion.

An example of an auction conducted using auction system 10 will now be provided to illustrate features of embodiments of the present invention. In the example, participant 12a is a Korean company wishing to purchase computer equipment at auction. Participants 12b and 12c are German companies, and participant 12i is a U.S. company, each of which also wish to purchase computer equipment at auction. Each of the participants may have different requirements and equipment desires, including differences in export laws, delivery requirements, currency, or the like.

An auction service provider, a seller, or other entity, using techniques of embodiments of the present invention, may establish an auction system 10 which allows each of the participants 12a-n to competitively bid for industrial equipment against each other, despite the different geographical and other circumstances of each participant. As a result, each participant may enjoy greater auction savings and selection.

Auction system 10 includes, in this example, two secondary auctions 22a and 22b. Secondary auction 22a is an auction established for Korean bidders (including participant 12a). Secondary auction 22b is established and operated for German bidders (including participants 12b, 12c). For example, each secondary auction 22a, b may present auction information, inventory, and prices in the language and currency of the market served. In the example, each of these secondary auctions are established and configured to satisfy needs of a particular geographical market. Those skilled in the art will recognize that secondary auctions may also be configured to satisfy needs of a particular industry or market segment or the like.

In the example, each of the participants 12 are interested in purchasing computer equipment at auction (e.g., a specially-configured enterprise server computer). In the example, because the specially-configured enterprise server is a complex and expensive item, only auction 22n offers the item. According to embodiments of the present invention, the Korean bidder may bid on the item by submitting a bid to secondary auction 22a which then operates to forward the bid to primary auction 22n. According to some embodiments of the present invention, secondary auction 22a serves to both forward information and to apply transformation functions associated with participants 12 to primary auction 22n. As a result, individual auctions and auction administrators can provide access to a greater range of items and can also serve the role of applying one or more transformation functions 20 to bids and status inquiries of participants. In some embodiments, each secondary auction may further have one or more transformation functions associated with it which are applied to information transferred between the secondary auction and the primary auction.

In the example, the Korean bidder (participant 12a) may wish to acquire an enterprise server, and may wish it to be configured in a particular way (e.g., with the Linux® operating system, and with a particular memory and processor configuration, and with a Korean user interface). Further, participant 12a may be subject to particular export control laws because the primary auction takes place in the U.S. Each of these particular circumstances of participant 12a may be applied to a bid or status request submitted by participant 12a using one or more transformation functions 20 associated with the participant, the participant's bid or other information related to the transaction. Similarly, the German participants 12b, c may submit bids on enterprise servers offered in the primary auction 22n via secondary auction 22b. Particular circumstances and requirements of each participant may be applied to the bid or status using one or more transformation functions 20 associated with the participant, the participant's bid or other information related to the transaction. For example, the German participants may submit their bids in German Marks, and may require a different server configuration and leasing terms than the Korean bidder. These particular desires may be applied to their bids using one or more transformation functions 20.

Participant 12i (not shown), in the example, may directly submit a bid on the enterprise server offered in primary auction 22n. The bid submitted by participant 12i may also be transformed using one or more transformation functions associated with the participant, the bid or other information associated with the transaction. As a result, a wide diversity of participants may participate in the auction for the enterprise server. By allowing bids to be forwarded from secondary auctions 22a, b, the volume of bids in the primary auction 22n is increased, thereby achieving better auction pricing for both buyers and sellers of items. Further, through the use of one or more transformation functions 20, the particular requirements and circumstances of differently situated participants may be taken into consideration and assessed on a common basis.

Further details and benefits of embodiments of the present invention will be described below. A description of one embodiment of an auction administrator device will first be described, along with a discussion of data stored at or accessible to the device pursuant to embodiments of the present invention.

Devices

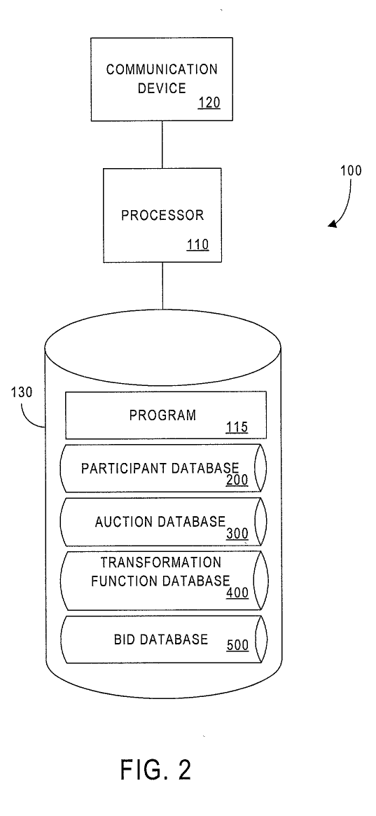

FIG. 2 illustrates an embodiment of an auction administrator device 100 which may be operated by an auction administrator 16 in the system of FIG. 1. Auction administrator device 100 may be used in embodiments where an auction administrator is used to administer and conduct an auction pursuant to the invention. In other embodiments, a buyer, a seller, an auction service provider or other entity may participate in the administration of the auction.

Administrator device 100 may be implemented as a system controller, a dedicated hardware circuit, an appropriately programmed general purpose computer, or any other equivalent electronic, mechanical or electromechanical device. Administrator device 100 comprises a processor 110, which may be any of a number of suitable processing devices, such as one or more Intel® Pentium® processors. Processor 110 is coupled to a communication device 120 through which processor 110 communicates with other devices, such as, for example, one or more participant devices 12 operated by buyers and/or sellers participating in the auction, and auction service provider devices (not shown) operated by auction service providers providing value-added services in support of an auction (each of which devices may also be implemented as general purpose computer or other equivalent electronic, mechanical, or electromechanical device).

Communication device 120 may include hardware and software to facilitate communication with other devices using wired or wireless techniques, or a combination of different techniques. For example, communication device 120 may be one or more of: a network adapter, a modem, a Bluetooth device, etc. In one embodiment, communication device 120 facilitates communication with other devices over a network such as the Internet. Processor 110 may also be in communication with one or more input and output devices (not shown) as are known in the art (such as, for example, a keyboard, mouse, microphone, monitor, printer, etc.).

Processor 110 is also in communication with a data storage device 130. Data storage device 130 comprises an appropriate combination of magnetic, optical and/or semiconductor memory, and may include, for example, Random Access Memory (RAM), Read-Only Memory (ROM), a compact disc and/or a hard disk. Processor 110 and data storage device 130 may each be, for example: (i) located entirely within a single computer or other computing device; or (ii) connected to each other by a remote communication medium, such as a serial port cable, telephone line or radio frequency transceiver. In one embodiment, administrator device 100 may comprise one or more computers that are connected to a remote server computer for maintaining databases.

Data storage device 130 stores a program 115 for controlling processor 110. Processor 110 performs instructions of program 115, and thereby operates in accordance with the present invention, and particularly in accordance with the methods described in detail herein. Program 115 may be stored in a compressed, uncompiled and/or encrypted format. Program 115 furthermore includes program elements that may be necessary for allowing processor 110 to interface with computer peripheral devices, such as an operating system, a database management system and “device drivers”. Appropriate program elements are known to those skilled in the art, and need not be described in detail herein.

According to an embodiment of the present invention, the instructions of program 115 may be read into a main memory from another computer-readable medium, such as from a ROM to RAM. Execution of sequences of the instructions in program 115 causes processor 110 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 130 also stores (i) a participant database 200, (ii) an auction database 300, (iii) a transformation function database 400, and (iv) a bid database 500. These databases are described in detail below and depicted with exemplary entries in the accompanying figures.

Databases

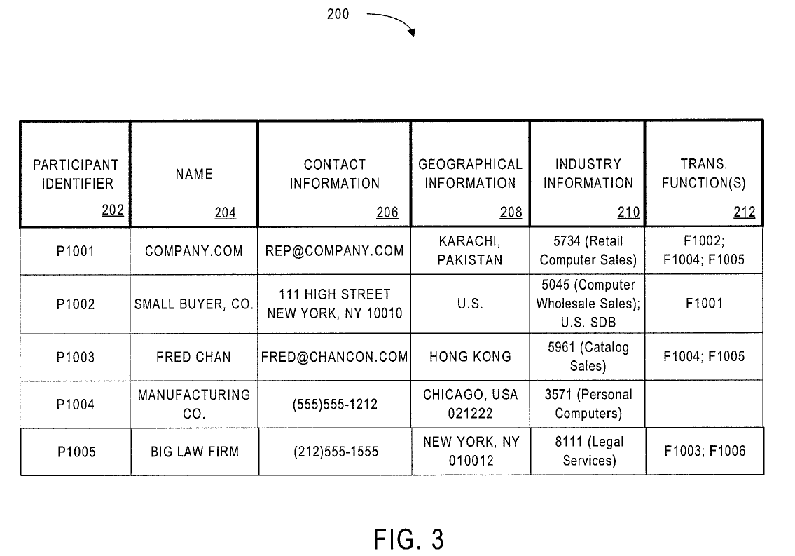

Each of the databases referred to in FIG. 2 will now be described by referring to FIGS. 3-6. While the databases are shown as being stored at, or accessible by, administrator device 100, portions of or all of the data in one or more of the databases may be stored at or accessible to other devices in the system. For example, in some embodiments, transformation functions may be stored at (or accessible to) devices operated by other participants in an auction, such as devices operated by buyers, sellers, or service providers. As another example, a single administrator device 100 may be used to operate multiple auctions (e.g., auctions 22a-n in FIG. 1), while in other embodiments, each auction may be operated by a single administrator device 100.

As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

Participant Database

Referring to FIG. 3, a table is shown representing a participant database 200 that may be stored at, or accessible by, auction administrator device 100 according to an embodiment of the present invention. The table includes entries identifying a number of different entities and/or individuals that have been identified as participating in an auction (e.g., either a secondary or primary auction of FIG. 1) pursuant to the present invention. Participants identified in participant database 200 may include parties acting as buyers in an auction as well as parties acting as sellers in an auction. This information may be stored in database 200 when a participant registers for participation in one or more auctions.

The table shown in FIG. 3 defines a number of fields 202-212 for each of the entries. In the embodiment depicted, the fields specify: a participant identifier 202, a name 204, contact information 206, geographical information 208, industry information 210, and transformation function(s) 212.

Other fields and combinations of fields may also be used to provide and access information about different participants in an auction. For example, in some embodiments, a field indicating membership in a particular group or organization may also be provided in participant database 200.

Participant identifier 202 may be, for example, an alphanumeric code or other information that is associated with and used to identify a participant who has registered to participate in one or more auctions pursuant to embodiments of the present invention. Participant identifier 202 may be generated by, for example, auction administrator device 100 (FIG. 2) or it may be provided by a participant. The participant's individual or company name may be provided in name 204, while information used to contact the participant may be provided in contact information 206.

Geographical information 208 may be, for example, information identifying particular geographical information about the participant identified by participant identifier 202 which may be used in embodiments of the present invention to generate, identify, or otherwise apply transformation functions to bids and/or status inquiries submitted by or on behalf of the participant. Geographical information 208 may be information provided by or on behalf of the participant indicating the country, region or area where the entity is located (which may be, for example, the entity's legal place of business) or the location where the item should be shipped, or the like.

Industry information 210 may be, for example, information identifying an industry or industry segment in which the participant identified by participant identifier 202 functions. Industry information 210 may include, for example, standardized industry codes (SIC) or other data used to specify a particular industry. In some embodiments, auction administrator 16 or other entities (alone or in combination) associated with system 10 (FIG. 1) may establish customized industry information for one or more auctions conducted using system 10. For example, an auction administrator 16 which conducts auctions of computer equipment which are frequented by participants having specialized industry requirements may establish customized industry information for each of the different industries. For simplicity and clarity of exposition, simple identifiers of industry segments are shown in participant database 200. Those skilled in the art will recognize that other types and sources of industry information may be used.

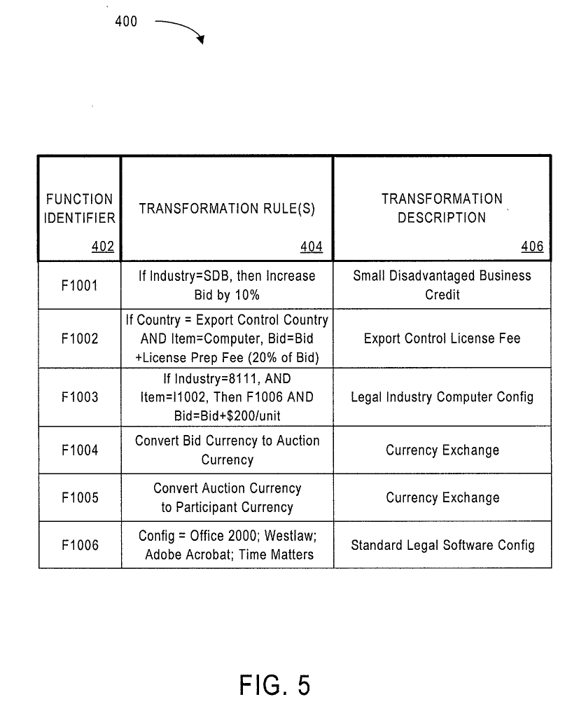

Transformation function(s) 212 may be, for example, information identifying particular transformation function(s) associated with the participant (e.g., by referring to function identifiers defined in transformation function database 400 of FIG. 5). Rules describing circumstances in which one or more transformation functions associated with the participant may be applied may also be defined at 212. Information may be stored at 212 upon completion of a transformation binding process (e.g., such as the process described below in conjunction with FIG. 7), or may otherwise be specified by the participant, auction administrator, auction service provider, or other parties. Any of a number of different transformation functions may be referenced. Further, any of a number of different rules for applying the transformation functions for a particular participant may also be provided.

In some embodiments, where participant information is stored at different administrator devices 100 (e.g., where each auction stores its own participant information), participant database 300 may also include information identifying the particular administrator device 100 or auction in which the participant's information is stored.

In the table depicted in FIG. 3, participant information is stored in participant database 200, which is stored at or accessible by auction administrator device 100. In other embodiments, participant information (or some portion thereof), may be stored at other locations, such as a database stored at or accessible to participant device 12 or auction service provider device. In such embodiments, participant information may be requested from the device that is storing or has access to the information, or it may be requested by other devices in the system.

In some embodiments, further participant information may be specified to precisely identify appropriate transformation functions. This information could include, for example, information specifying the nature of the participant, such as participant business, industry, demographic, and psychographic information. Other information may also be provided, such as information identifying participant purchasing behaviors, including: historical bidding information, click stream and other response information from other Web-sites or exchanges, and purchasing behavior from other sales and distribution channels.

Still other information may be provided identifying participants or groups of participants, such as transaction histories in other sales and distributions channels, or transaction histories for sales or purchases of goods or services unrelated to items being offered in the present auction. This information may include information related to the future cost of servicing a particular participant, such as warranty and other terms typically provided to the participant in these and other transactions. Yet other information may be provided which identifies participant behavior post-transaction, such as return rates or estimates of anticipated future transactions. Other information might also include information to ascertain participants' level of interest in a particular item, such as historical responses to sales inquiries about the item, or feedback provided by sales representatives or customer service representatives about the participant. Those skilled in the art will recognize that other information may also be provided which may allow the creation, selection and application of appropriate transformation functions for a particular participant or group of participants.

Auction Database

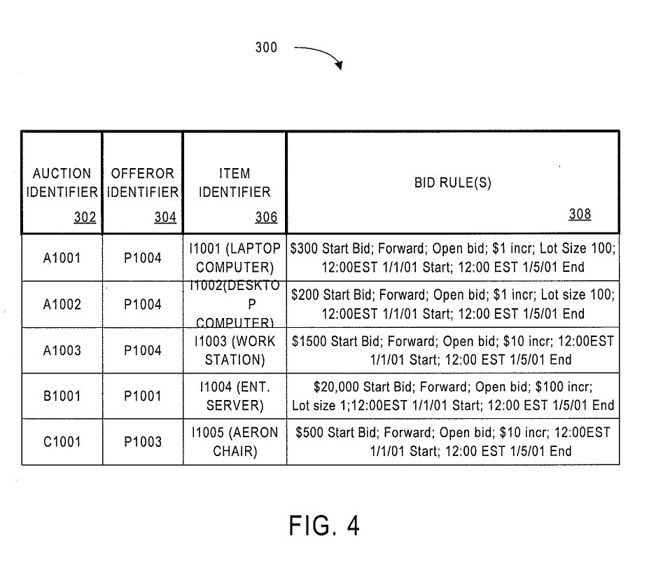

Referring now to FIG. 4, a table is shown representing an auction database 300 that may be stored at, or accessible to, auction administrator device 100 (FIG. 2) according to an embodiment of the present invention. The table includes a number of entries identifying one or more auctions that are operated by the auction administrator. The table also defines fields 302-308 for each of the entries. The fields specify information used to identify each of the auctions administered by the auction administrator, including for example: an auction identifier 302, an offeror identifier 304, an item identifier 306, and one or more bid rule(s) 308. The information in auction database 300 may be created and updated, for example, when an auction administrator establishes an auction using features of embodiments of the present invention. This information may be entered by an auction administrator operating auction administrator device 100. In some embodiments, the information may also be entered by other parties, such as a participant operating participant device 12 or a service provider operating an auction service provider device. As an example, in the system of FIG. 1, each of the auctions 22a-n may be defined in an auction database 300 stored in one or more auction administrator devices 100.

Auction identifier 302 may be, for example, an alphanumeric code associated with an auction administered by an auction administrator. Auction identifier 302 may be generated by, for example, auction administrator device 100.

Offeror identifier 304 may be, for example, the same as or related to participant identifier 202 of participant database 200. Offeror identifier 304 identifies the party in the auction identified by auction identifier 302 who is soliciting bids on an item. For example, in a sell-side auction, the offeror identifier 304 identifies a participant who has posted an item for sale via the auction identified by auction identifier 302. In a buy-side auction, on the other hand, the offeror identifier 304 identifies a participant interested in purchasing and item or items, and is soliciting bids from prospective sellers via the auction identified by auction identifier 302.

In some embodiments, offeror identifier 304 may identify an offeror that does not have a participant identifier (from participant database 200). In such cases, additional information identifying the offeror may be provided, for example, in auction database 300.

Item identifier 306 may be, for example, information identifying one or more items for which bids are being solicited in the auction identified by auction identifier 302. The information may include, for example, a product code such as a Universal Product Code (UPC) or other information particularly identifying the item(s). In the depicted embodiment, item identifier 306 simply includes an alphanumeric designator along with a brief description of the item. In other embodiments, further details of offered items may be specified to precisely identify items offered by auction. These details could include descriptions of product or service characteristics, images depicting a product or service, information about the manufacturer or provider of a product or service, information about delivery terms associated with a product or service, links to web pages with further information about the product or services, links to web pages with further information about the manufacturer or provider of a product or service, etc.

Bid rule(s) 308 may include information identifying one or more rules that govern the bidding process of the auction identified by auction identifier 302. For example, bid rule(s) 308 may include rules specifying a starting bid for the item, whether the auction is a forward or a reverse auction, whether the auction is public or private, whether bidding will be anonymous or not, the type of auction (e.g., open cry, sealed-bid, Dutch, English, etc.), a minimum bid increment, a start time, an end time, a reserve price, etc. In some cases, these rules may specify other databases or database fields with further information required to process the rule. For example, if a rule specifies that an auction is a private auction, it might include a reference to another database specifying qualified participants in the private auction. Other rules necessary to govern the conduct of the auction identified by auction identifier 302 may also be provided in bid rule(s) 308.

In the example data shown in FIG. 4, one seller (participant identifier P1004) is soliciting bids in three different auctions for three different items (laptop computers, desktop computers, and work stations). Each of the auctions in which P1004 is soliciting bids are forward open cry auctions, with established starting bids and bid increments. Each auction also has specified starting and ending times. Another seller, P1001 is participating in auction B1001, while seller P1003 is participating in auction C1001, each of which are forward open cry auctions. Three different auction administrators are designated in the example data of FIG. 4 (designated as auctions “Axxxx”, “Bxxxx”, and “Cxxxx”).

Transformation Function Database

Referring to FIG. 5, a table represents a transformation function database 400 that may be stored at (or accessible to) auction administrator device 100 (FIG. 2) according to an embodiment of the present invention. The table includes a number of entries identifying different transformation functions that may be applied to information in auctions operated pursuant to embodiments of the present invention. The table also defines a number of fields 402-406 for each of the entries. The fields specify: a function identifier 402, transformation rule(s) 404, and a transformation description 406. The information in transformation function database 400 may be created and updated, for example, by an auction administrator based on information received from individual participants in an auction.

Other fields and combinations of fields may also be used to identify and characterize participants. For example, in some embodiments, a single “primary” auction may represent the composition of multiple sub-auctions. In this case, there would be an additional field describing a participant's originating auction. Information about the originating auction could be used to identify geographical, industry, and other information about the participant. In certain embodiments, there could also be particular transformation functions directly associated with certain originating auctions or marketplaces.

Function identifier 402 may be, for example, an alphanumeric code associated with a particular transformation function that may be used in an auction operated pursuant to embodiments of the present invention. A number of different function identifiers 402 may be established for use in an auction.

Transformation rule(s) 404 may be, for example, information identifying one or more rules that are applied when the transformation function identified by function identifier 402 is used. Transformation rule(s) 404 may include any of a number of different types of rules including rules that operate on the amount of an offer to purchase or an offer to sell, rules that operate on a bid or offer quantity or configuration, or the like. Examples of different types of transformation rule(s) 404 which may be applied using embodiments of the present invention include rules which apply industry standard configurations, safety requirements, or terms (such as warranty terms, delivery terms, payment terms or the like), etc. Other types of transformation rule(s) 404 may apply geographical terms, such as currency, shipping, export rules, or the like. These transformation rule(s) may be established for a particular participant (e.g., the rules may particularly define specific geographical or industry segment needs for a specific participant), or they may be generically created for multiple participants (e.g., currency conversion may always be applied in an auction to transform a buyer's local currency to the functional currency or default currency of an auction).

In the example data in the table of FIG. 5, several transformation functions are shown which operate based on industry-related information (e.g., function F1001 applies if a participant is a Small Disadvantaged Business as defined by the U.S. Small Business Administration, and function F1003 applies if a participant is a legal services provider defined by SIC code 8111), and several transformation functions are shown which operate based on geographical-related information (e.g., function F1002 applies U.S. export control rules based on geographical information, and functions F1004 and F1005 apply currency conversion rules based on the participant's currency and the auction currency). According to some embodiments, application of a transformation function may depend on reference to extrinsic data. For example, application of function F1002 may require reference to current U.S. Department of Commerce Export Control rules (in the example, reference may be made to the current version of License Exception rules pertaining to the export of high-performance computers).

Transformation rule(s) 404 may be expressed in any of a number of different functional forms, including functions that operate on the amount of an offer to purchase or offer to sell, functions that operate on a bid or offer quantity or configuration, or the like. Examples of different types of functional forms for transformation rule(s) 404 which may be applied using embodiments of the present invention include functional forms such as: a fixed percentage multiplier of a bid, offer, or auction status; a percentage multiplier of a bid, offer, or auction status that varies with a quantity of said bid; a percentage multiplier of a bid, offer, or auction status that varies with a magnitude of a bid, offer, or auction status; a fixed addition to said bid price; a fixed addition to said bid price that varies with a magnitude of a bid, offer, or auction status; an amount added to the bid price that varies with a magnitude of a bid, offer, or auction status; a linear function; and a non-linear function.

In one embodiment of the present invention, transformation rule(s) 404 may be described in terms of a functional model, with associated model parameters. In such embodiments, entries in transformation function database 400 may include a transformation rule 404 describing the functional form of the transformation function, accompanied by at least one parameter associated with the transformational form. For example, a simple parameterized model to represent increasing a bid by 10% could be represented by the functional form “TRANSFORMED BID=PARAMETER* ORIGINAL BID”, with an associated parameter of “1.10”.

Transformation rule(s) 404 may include rules establishing that a discount or other transformation be performed only if certain conditions are met. For example, some transformations may only be available to participants dealing with a particular participant (e.g., a seller may grant a strategic partner discount to a particular buyer). Other transformations may only be available if the bid amount or other terms of bid meet specified criteria (e.g., a buyer may receive a discount if the offer to purchase amount is above a predetermined threshold). Those skilled in the art, upon reading this disclosure, will recognize that a number of other different types and combinations of transformation rule(s) 404 may be applied using features of the present invention.

Transformation description 406 may be, for example, information describing the function identified by function identifier 402. Further, information at 406 could include information to be displayed to participants of the auction during the auction.

Bid Database

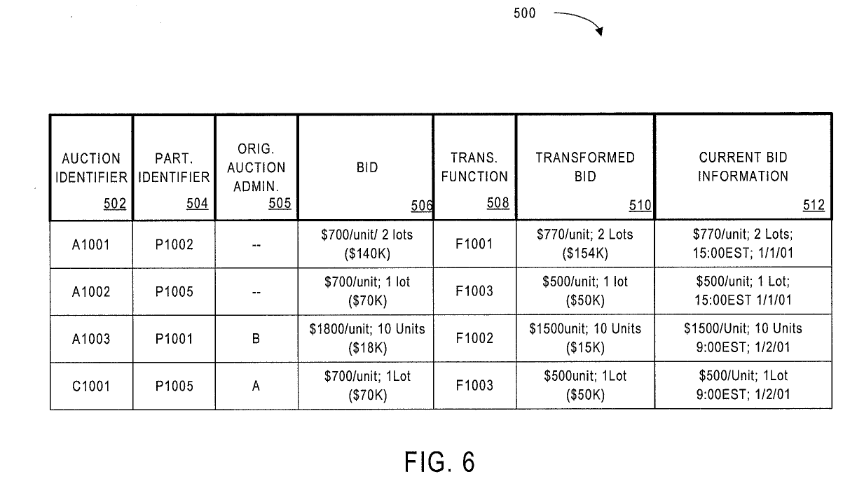

Referring now to FIG. 6, a table is shown which represents a bid database 500 that may be stored at, or accessible by, auction administrator device 100 according to an embodiment of the present invention. The table includes a number of entries identifying bids that have been received in auctions administered by an auction administrator operating auction administrator device 100. The table depicted in FIG. 6 represents data stored at an example auction administrator device in a primary auction which has received bids from several participants via different routes (two bids received via secondary auctions, and one bid received directly from a participant in the primary auction).

For clarity of exposition, only a few exemplary bids are illustrated in the table shown in FIG. 6. As described in the definitions set forth above, “bids” as used herein may refer to either offers to purchase or offers to sell (depending on the type of auction operated), therefore, bid database 500 may record information about offers to sell (e.g., in the case of a buy-side auction), offers to purchase (e.g., in the case of a sell-side auction), or both offers to purchase and offers to sell (e.g., in the case of a two-sided auction).

The table also defines a number of fields 502-512 for each of the entries. The fields specify: an auction identifier 502, a participant identifier 504, an originating auction administrator 505, a bid 506, a transformation function 508, a transformed bid 510, and current bid information 512. The information in bid database 500 may be created and updated, for example, each time auction administrator 16 receives a bid from a participant in an auction being operated by auction administrator 16. Some or all of the information stored in bid database 500 may be received via communication network 18 in any of a number of different formats. For example, bids (and other information transmitted pursuant to the invention) may be submitted by (or to) participants 12 via electronic data interchange (EDI) messages, via Extensible Markup Language (XML) messages, via instant messaging, via electronic mail, via Web-based forms, via telephone or facsimile, telex, etc.

Auction identifier 502 may be, for example, based on or identical to auction identifier 302 of auction database 300, and is used to associate a particular bid with a particular auction. Each auction identified by an auction identifier 502 may have a number of entries representing individual bids received for that auction. In the table shown in FIG. 6, only the current best bid in each auction is shown. However, other bids and offers, including a previous best bid or bids, or current bids that are not the current best bid, could also be recorded in bid database 500. For example, in a continuous two-sided auction, a buyer may place a bid that at the time of the bid may not be the current best bid, but which may become the current best bid as market conditions change over time.

Participant identifier 504 may be, for example, based on or identical to a participant identifier 202 of participant database 200 and is used to identify a particular participant (such as a buyer or seller) in an auction. Each participant in an auction may submit multiple bids and, therefore, bid database 500 may contain multiple entries for a participant in a particular auction. In the example data depicted in FIG. 6, bid data is shown for three different participants (buyers P1001 P1002, and P1005) bidding in four different auctions (auctions A1001, A1002, A1003 and C1001). In two of the auctions (A1003 and C1001), the bid was received from participants via another auction administrator (e.g., via a secondary auction).

Originating auction administrator 505 may be, for example, information identifying a particular auction administrator which forwarded the bid identified by bid 506 to the primary auction identified by auction identifier 502. In the depicted example data, each auction administrator is assigned a different alphanumeric identifier (here, “A”, “B” or “C”). As shown, a bid has been received in auction A1003 via the auction administrator referred to as “B”, and a bid has been received from administrator “A” in auction C1001. Those skilled in the art will recognize that other types of identifiers and data may be used to associate received bids with the originating participant and the forwarding auction administrator.

Bid 506, may be, for example, information identifying a particular bid made by a participating buyer or seller. In the embodiment depicted, only information reflecting the current best bid in each auction is depicted. In some embodiments, data will also be stored indicating the bid history of the auction, including all bids received (whether or not a bid is the current best bid or not). The information in bid 506, in one embodiment, reflects non-transformed bid information. For example, referring to the first row of the table shown in FIG. 6, bid 506 made by participant P1002 is a bid to purchase two (2) lots of the item being auctioned in auction A1001 (reference to auction database 300 shows that item I1001—laptop computers—are the items being auctioned) at a bid price of $700/unit. Participant P1005 is bidding on desktop computers, while participant P1001 is bidding on computer workstations.

In some embodiments, there may be more than one current best bid or offer for each auction. For example, in some auctions, a single lot containing multiple items may be offered to multiple buyers. Bid database 500 may also be used to record former current best bids to provide a bid history or audit trail. For example, this information may be used to track the bidding history of different buyers and/or to award units being sold in the auction to a substitute buyer in the case where a current best buyer (or group of current best buyers) is unable to settle their auction trade. In some embodiments, bid database 500 may also be used to record current bids that are not the best bid.

Transformation function 508 may be, for example, the same as or related to one or more transformation function identifiers 402 of transformation database 400. For example, depending on the bid, the participant, and the auction, one or more transformation functions may apply. In the example data shown in FIG. 6, the bid made by participant P1002 is transformed by transformation function identifier F1001 (applying a 10% Small and Disadvantaged Business credit). The bid made by participant P1005 in auction A1002 is transformed by the transformation function identified by identifier F1003 (applying a Legal Industry software configuration to the computers bid upon, and adjusting the bid price accordingly), while the bid made by participant P1001 in auction A1003 is transformed by transformation function F1002 (applying an Export Control License Fee to the bid amount). In the example data shown in FIG. 6, a single transformation function is associated with each entry. However, in some instances, there may be no transformation function associated with a bid by a participant in an auction, so there would be no entry in transformation function field 508 in bid database 500. In other cases, there may be multiple transformation functions associated with a single bid by a participant in an auction, so there would be multiple entries in transformation function field 508 in bid database 500.

Transformed bid 510 may be, for example, information reflecting bid 506 after application of transformation function 508. In the example data shown in FIG. 6, in the first row, the bid made by participant P1002 ($700/unit) has been transformed by applying the 10% Small and Disadvantaged Business credit to arrive at a transformed bid of $770/unit.

Current bid information 512, may be, for example, information identifying the current best bid in a particular auction. In a forward sell-side auction, the current best bid is the highest offer received. The best bid in a buy-side auction may be the lowest price offered for an item. Current bid information 512, may be, for example, information identifying a current status of the auction identified by auction identifier 502. The nature and content of this information may depend on the type of auction. For example, in a typical Open cry, forward, sell-side auction, current bid information 512 may include a current high bid amount and a current high bid quantity.

Other information necessary or useful in identifying a current bid status may also be provided in current bid information 512 (e.g., the time of the current bid may also be provided). In one embodiment, this current bid information 512 represents the current bid status at a particular moment in time (e.g., upon receipt and processing of the current bid received by the participant identified by participant identifier 504 in the auction identified by auction identifier 502).

In the data shown in FIG. 6, current bid information 512 reflects the current best bid in the auction. This current bid information 512 may be provided to participants to reflect the current status of the auction (e.g., informing potential participants of the current best bid). In some embodiments, as will be described further below, current bid information 512 may be further transformed before it is communicated to certain participants.

Those skilled in the art will recognize that other types of data may be included in bid database 500. For example, other types of information may be required in different types of auctions. A two-sided auction may require tracking limit orders and may also require tracking the expiration date and time of the limit orders. Other types of auctions may allow submission (and thus require tracking) of bids that are contingent on the occurrence or non-occurrence of some event. Other systems architectures are possible as well. For example, to improve system response times, historical bid information may be stored in a separate database.

PROCESS

Processes pursuant to embodiments of the present invention will now be described by referring to FIGS. 7-9. In particular, a transformation binding process, a bid process, and a transaction process will be described. In one embodiment, the processes described in FIGS. 7-9 are conducted under the direction of computer program code stored at auction administrator device 16, participant device 12 and/or an auction service provider device (or any combination thereof). The particular arrangements of elements in the flow charts of FIGS. 7-9 are not meant to imply a fixed order to the steps; embodiments of the present invention can be practiced in any order that is practicable.

Transformation Binding Process

Referring now to FIG. 7, a transformation binding process 600 pursuant to one embodiment of the present invention is shown. Transformation binding process 600 may be performed using devices of system 100 (FIG. 1) to establish one or more transformation functions for use in auctions conducted pursuant to embodiments of the present invention. As an example, process 600 is a transformation binding process conducted to establish transformation functions for use by a participant in one or more auctions conducted pursuant to embodiments of the present invention. In other embodiments, a similar transformation binding process 600 may be conducted to establish transformation functions used by all qualifying participants in an auction or auctions.

As an example, process 600 may be conducted to establish transformation functions used for a buyer, and the process may involve interaction between a buyer operating buyer device 12a-i and an auction administrator operating auction administrator device 16 via a communication network 18 such as the Internet. As another example, process 600 is a transformation binding process for a seller, involving interaction between a seller operating seller device 12n-z and an auction administrator operating auction administrator device 16.

In some embodiments process 600 occurs during a participant registration process. In other embodiments, process 600 is conducted separately to establish transformation functions for similarly-situated participants (e.g., participants meeting certain geographical or industry criteria). In some instances, such transformation functions may apply only to a single auction, while in other instances such transformation functions may be utilized in multiple auctions. In some embodiments, process 600 may establish transformation functions that apply to groups or classes of participants, rather than individual participants. In some embodiments, transformation functions established by process 600 apply to all bids made by a participant. In other embodiments, process 600 establishes one or more transformation functions intended for use with one or more particular bids by a participant or set of participants.

Process 600 begins at 602 where a participant is identified. The participant may be identified by any of a number of other techniques. For example, a participant interacting via e-mail may be identified by its e-mail address. A participant interacting via a Web-site may be identified by a user name, and the participant's identity may be authenticated using a password verification process. Processing at 602 may also include identifying the entity with which the participant is interacting (e.g., the identity of the auction administrator 16, etc.) A participant interacting via a Web-site operated by an auction administrator in Germany, for example, may be identified by the participant's information as well as information identifying the auction administrator in Germany (e.g., such as the domain name of the Web-site with which the participant interacts, an auction administrator identifier, or the like).

Participants may also be identified by an identification number, such as an account number, a credit or debit card number, or a social security number. For XML and EDI transactions, the participant could be identified by fields located within XML or EDI messages. Participants interacting via facsimile or telephone may be identified using information about the originating telephone number. Participants could also be identified using cookies stored on a participant device 12.

Once the participant has been identified at 602, processing continues to 604 where participant information is received. This information is used to generate, select, or otherwise establish transformation function(s) for the participant, and may include any information useful or necessary to establish one or more transformation functions for the participant. For example, information received at 604 may include geographical location information about the participant, shipping information, export information, import information, industry segment information, industry characteristic information, group characteristic information (e.g. membership in or affiliation with a group such as a religious organization, a non-government organization, a business entity, etc.

In one embodiment, this information may be solicited using a series of registration questions that are presented to the participant for response. For example, in embodiments where the participant is operating a participant device and interacting with an auction administrator device via the Internet, this information may be solicited by presenting the participant with a set of forms for entry and/or a checklist of options that may be selected by the participant. Other methods of soliciting and collecting information may also be used to establish transformation function(s). For example, third party databases may be accessed to collect some information. Such third party databases may include, for example: credit service bureaus, banks, rating agencies, export-import agencies, expediting firms, logistics providers, insurance companies, medical agencies, check processing agencies, advertising agencies, motor vehicle departments, census bureaus, credit card agencies, governmental bodies, non-governmental organizations, non-profit organizations, or the like.

Once attribute information has been received at 604, processing continues to 606 where one or more transformation functions are established for the participant. Transformation functions may be established in any of a number of different ways. For example, an auction administrator operating auction administrator device 16 may establish a set list of transformation functions and qualifications for those functions. In such an embodiment, processing at 606 may simply involve matching the established transformation functions with participant attribute information received at 604 to identify those functions that apply to a particular participant. For example, a foreign company participant registering as a buyer of computer goods in an auction conducted for a seller in the U.S. may always be associated with one or more currency conversion transformation functions (converting bid and status information to and from the participant's bidding currency) and may sometimes be associated with export-control related functions (e.g., if the participant's country is on a U.S. government export control list). A participant who qualifies for a particular transformation function may be associated with the transformation function by, for example, storing information that is accessible to auction administrator device 100 that associates the function identifier 402 in transformation function database 400 (FIG. 5) with the participant identifier 202 in participant database 200 (FIG. 3).

Processing at 606 may include the establishment of a new transformation function as well. For example, a buyer participant may establish preferred shipping terms based on his geographical information. This preference may be defined in transformation function database 400 (FIG. 5) and associated with the appropriate participant.

Those skilled in the art, upon reading this disclosure, will recognize that other techniques may be used to establish transformation functions for use in embodiments of the present invention.

Bid Process

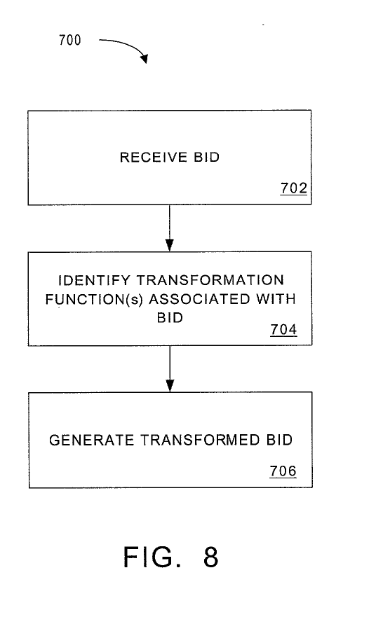

Referring now to FIG. 8, a bid process 700 pursuant to one embodiment of the present invention is shown. In one embodiment, bid process 700 is performed after an auction has been established for one or more items. In one embodiment, a participant may act as a buyer in the auction after one or more transformation functions have been established (e.g., via the transformation binding process 600 described in FIG. 7 above). In some embodiments, bid process 700 and transformation binding process 600 are performed during a single session. In one embodiment, bid process 700 is conducted under the direction of auction administrator device 16.

Processing begins at 702 where a bid is received. In one embodiment, the bid is received by auction administrator device 16 from a buyer operating buyer device 12a-i. Typically, the bid is received from the buyer after the buyer has had the opportunity to view the terms and conditions of the auction and read a description of the item(s) being offered in the auction. Further, unless the auction is of the sealed bid type or multiple-unit type, the buyer has also typically determined that it is willing to beat the current best bid on the item. In one embodiment, buyer device 12a-i transmits the bid to auction administrator device 16 over a network such as the Internet. Further, in one embodiment, the buyer views information about the auction by directing a Web-browser to an Internet site maintaining information about the auction.

The bid received at 702 may include information identifying the particular auction and/or sub-auction in which the bid is made, as well as information identifying the item bid on. The bid also typically includes terms of the bid such as a price term, a quantity term, a configuration term, and a delivery term.

Processing continues at 704, where one or more transformation functions associated with the bid received at 702 are identified. In one embodiment, one or more transformation functions are identified by auction administrator device 16 (e.g., by retrieving information contained in, for example, participant database 200, and/or transformation function database 400). A number of different techniques may be used to identify one or more transformation functions associated with a bid. Transformation functions may be identified based on: an identity of the buyer, an identity of the seller (or a relationship between the seller and the buyer), an identity of an auction or marketplace in which a buyer or seller initiated a transaction, information about the seller, information about the item, information about the status of the auction, information about prices for comparable items in other markets, bidding history in the current auction, bidding histories in other auctions, and/or characteristics of the bid.

In some embodiments, bids or buyers (or sellers) may be associated with multiple transformation functions. In such cases, the transformation function(s) to be applied may be identified based in part on the other specified transformation function(s). For example, a buyer entitled to receive a special discount may not simultaneously be entitled to a volume discount credit. As another example, a buyer who has achieved a volume discount target may be entitled to application of a transformation function that waives an auction fee. In some cases, a transformation function associated with a bid may be identified based on a transformation function associated with a status request by the buyer (e.g., where the bid transformation function is the inverse of the status request transformation function). In some embodiments, a status request transformation function may be identified based on a bid transformation function. Transformation functions may also be identified and applied using combinations of any of the above factors.

In some embodiments, processing at 704 may involve checking multiple sources to identify relevant transformation function(s). For example, processing at 704 may simply involve a search for transformation functions accessible to auction administrator device 16, or it may involve a search for transformation functions at auction administrator device 16, participant device 12 and/or auction service provider device 24. Other sources of transformation functions may also be provided.

Once one or more transformation functions have been identified at 704, processing continues at 706 where a transformed bid is generated. This transformation may involve applying one or more transformation functions to the bid received at 702. In some embodiments, the transformation may require reference to extrinsic data. For example, a transformation function which requires conversion from one currency to another may involve reference to an external source of foreign exchange rate data. This reference may be performed in conjunction with processing at 706.

Once the bid has been transformed, the transformed bid is presented to the auction as the bidder's bid. The transformed bid is then considered pursuant to the auction rules. For example, in a forward English auction, the transformed bid will be compared with the current best bid to determine if the transformed bid is greater than the current best bid. If it is, then the transformed bid becomes the auction's current best bid, and any subsequent bid must be greater than the transformed bid to be successful. In this manner, embodiments of the present invention permit a bidder's special circumstance to be factored into the bidder's bid.

Transaction Process

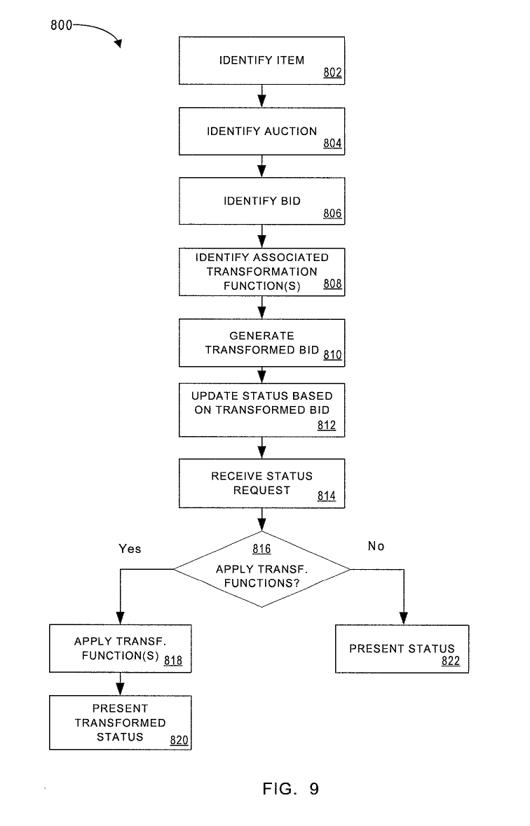

Referring now to FIG. 9, a transaction process 800 pursuant to one embodiment of the present invention is shown. In one embodiment, bid process 800 is performed after an auction has been established for one or more items. In one embodiment, a participant may act as a buyer in the auction after one or more transformation functions have been established (e.g., via the transformation binding process 600 described in FIG. 7 above). In some embodiments, transaction process 800 and transformation binding process 600 are performed during a single session. In one embodiment, transaction process 800 is conducted under the direction of auction administrator device 16.

Process 800 describes a process where one participant in an auction submits a bid and the bid is transformed and used to update a status of the auction. A second participant then checks the status of the auction. The auction status may then be transformed for viewing by the second participant.

Processing begins at 802 where information identifying a desired item is received from a participant. This information may be identified based on data received from a participant operating a participant device (such as device 12a of FIG. 1). Processing continues at 804 where an auction involving the item is identified. For example, referring to the system of FIG. 1, a participant operating participant device 12a may desired to purchase an item in an auction, and may submit information identifying the item to auction administrator 16a. If auction administrator 16a is operating one or more auctions in which the desired item is available, auction 22a will act as the primary auction to receive the participant's bid. However, if auction administrator 16a is not operating any auctions which offer the item desired by the participant, of if auction administrator 16a is not operating any auctions at all, auction administrator 16a will search other auctions (e.g., auctions 22b-n of FIG. 1) to determine if any other auction administrators 16 are conducting auctions involving the requested item. Any such auctions will be identified at 804. Details regarding the identified auction or auctions will be retrieved and presented to the participant.

If the participant chooses to submit a bid or offer on the item in any of the auctions identified at 804, the bid is received at 806. In one embodiment, the bid is received by auction administrator device 16 from a buyer operating buyer device 12. Typically, the bid is received from the buyer after the buyer has had the opportunity to view the terms and conditions of the auction and read a description of the item(s) being offered in the auction. Further, unless the auction is of the sealed bid type or multiple-unit type, the buyer has also typically determined that it is willing to beat the current best bid on the item. In one embodiment, buyer device 12 transmits the bid to auction administrator device 16 over a network such as the Internet. Further, in one embodiment, the buyer views information about the auction by directing a Web-browser to an Internet site maintaining information about the auction.

The bid received at 806 may include information identifying the particular auction and/or sub-auction in which the bid is made, as well as information identifying the item bid on. The bid also typically includes terms of the bid such as a price term, a quantity term, a configuration term, and a delivery term.

Processing continues at 808, where one or more transformation functions associated with the bid received at 806 are identified. In one embodiment, one or more transformation functions are identified by auction administrator device 16 (e.g., by retrieving information contained in, for example, participant database 200, and/or transformation function database 400). A number of different techniques may be used to identify one or more transformation functions associated with a bid. Transformation functions may be identified based on: an identity of the buyer, an identity of the seller (or a relationship between the seller and the buyer), an identity of an auction or marketplace in which a buyer or seller initiated a transaction, information about the seller, information about the item, information about the status of the auction, information about prices for comparable items in other markets, bidding history in the current auction, bidding histories in other auctions, and/or characteristics of the bid.

In some embodiments, bids or buyers (or sellers) may be associated with multiple transformation functions. In such cases, the transformation function(s) to be applied may be identified based in part on the other specified transformation function(s). For example, a buyer entitled to receive a special discount may not simultaneously be entitled to a volume discount credit. As another example, a buyer who has achieved a volume discount target may be entitled to application of a transformation function that waives an auction fee. In some cases, a transformation function associated with a bid may be identified based on a transformation function associated with a status request by the buyer (e.g., where the bid transformation function is the inverse of the status request transformation function). In some embodiments, a status request transformation function may be identified based on a bid transformation function. Transformation functions may also be identified and applied using combinations of any of the above factors.

In some embodiments, processing at 808 may involve checking multiple sources to identify relevant transformation function(s). For example, processing at 808 may simply involve a search for transformation functions accessible to a particular auction administrator device 16, or it may involve a search for transformation functions at other auction administrator devices 16, participant device 12 and/or an auction service provider device. Other sources of transformation functions may also be provided.

Once one or more transformation functions have been identified at 808, processing continues at 810 where a transformed bid is generated. This transformation may involve applying one or more transformation functions to the bid received at 806. In some embodiments, the transformation may require reference to extrinsic data. For example, a transformation function which requires conversion from one currency to another may involve reference to an external source of foreign exchange rate data. This reference may be performed in conjunction with processing at 810.

Once the bid has been transformed, the transformed bid is presented to the auction as the buyer's bid. In embodiments where the bid is submitted via a secondary auction, information identifying the secondary auction may be stored or otherwise associated with the buyer's bid. The transformed bid is then considered pursuant to the auction rules. For example, in a forward English auction, the transformed bid will be compared with the current best bid to determine if the transformed bid is greater than the current best bid. If it is, then the transformed bid becomes the auction's current best bid, and any subsequent bid must be greater than the transformed bid to be successful. In this manner, embodiments of the present invention permit a buyer's special circumstance to be factored into the buyer's bid.

Processing continues at 812 where a status of the auction is updated based on the transformed bid. Depending on the nature of the transformation function(s) identified at 808 and applied at 810, the transformed bid may be significantly different than the original bid identified at 806. In some embodiments, the transformed bid may be slightly changed (or even remain unchanged) from the original bid identified at 806. According to embodiments of the present invention, this process and use of a transformed status allows participants to compete in the same auction despite participating in different originating auctions, or having different geographical and/or industry circumstances.

In a typical auction, once a bid has been received and the auction status has been updated to reflect the current best bid, other potential buyers and participants in the auction will request a status of the auction. This remains unchanged in auctions conducted pursuant to embodiments of the invention. As shown in FIG. 9, a status request is received at 814. Unlike previous auctions, however, processing pursuant to embodiments of the present invention includes a determination at 816 of whether transformation function(s) should be applied to generate a transformed status of the auction. According to embodiments of the present invention, the status of the auction may be transformed based on transformation function(s) associated with a participant's originating auction, or geographical and/or industry circumstances requesting the auction status to present a transformed status to some participants. Other participants may view a non-transformed status.

According to some embodiments of the present invention, processing at 816 includes making a determination of whether one or more transformation function(s) should be applied to the auction status to generate a transformed status for the requesting participant. This determination may occur in any of a number of ways. For example, in some embodiments, the status request received at 814 may include an identification of the participant requesting the status, allowing reference to participant database 200 (FIG. 3) to determine the participant's originating auction, geographical and industry information. This information may be used to determine if a transformation function should be applied. Further, information about the auction and the item(s) being auctioned may also be used to determine if a transformation function should be applied.

As an example, referring to participant database 200 (FIG. 3) and transformation function database 400 (FIG. 5), if participant P1001 is the participant requesting status at 810, processing at 812 may involve a search of participant database 200 which will identify that participant P1001 is located in Karachi, Pakistan and is in SIC industry 5734. If the participant is seeking status in an auction involving certain export-controlled computers (such as auction A1003), processing at 816 will determine that transformation function F1002 should be applied. Other transformation functions may also be identified (e.g., a currency conversion function such as F1004 or F1005 may also be identified), based on the participant's geographical characteristics, industry characteristics, group characteristics, or originating auction or marketplace.

Once a determination has been made that transformation(s) of the status are required, processing continues to 818 where the identified transformation function(s) are applied to the status. In an example where the status request is issued by participant P1002, processing at 818 involves applying transformation function F1001 to the current status of the auction. If the current status of the auction is that the current best bid is a $1,100 bid for a laptop computer, then the transformed status generated at 818 will be that the current best bid is a $1000 bid (where the $100 credit represents the 10% SDB credit that participant P1002 is entitled to). This transformed status is presented to the requesting party at 820. Presentation of the transformed status may be accomplished in any of a number of different ways such as, for example, using XML or EDI transactions, instant messaging, e-mail, a Web-page, a telephone, facsimile, telex, etc. In some embodiments, if the requesting party has submitted the request via a secondary auction, the auction administrator of the secondary auction may present the auction status to the participant. In other embodiments, the primary auction may present the status directly to the requestor.

In some embodiments of the present invention, only the transformed status will be presented to the buyer or seller at 820. In other embodiments, however, both the transformed status and the untransformed status may be presented. In yet other embodiments, the transformed status may be presented in conjunction with a partially transformed status reflecting transformation by only a subset of the transformation functions that apply to the status request. In some embodiments, information about the transformation function applied to the status request is presented to the participant, while in other embodiments no information about the transformation function applied to the status request is presented to the participant. In yet other embodiments, various combinations of transformed, partially transformed, or untransformed status information are presented, with or without information about the associated transformation functions.

If processing at 816 indicates that no transformation of status is required (e.g., where the requesting participant is not associated with transformation function), processing continues to 822 where the status is presented to the requester. This non-transformed status may be presented in any of a number of different ways, such as, for example, using XML or EDI transactions, instant messaging, e-mail, a Web-page, a telephone, facsimile, telex, etc.

According to embodiments of the invention, transaction process 800 may be performed a number of times during an auction. The result is a system that allows personalization of bids (including offers to purchase and offers to sell), and auction status information based on each participant's particular circumstances. As a result, differently-situated participants may take part in a single auction, with the bidding in the auction and presentation of auction status transformed to reflect their particular situations. In particular, embodiments of the present invention permit participants in different originating auctions or marketplaces, or having different geographical and/or industry circumstances to bid on goods or services in a manner that adapts to each participant's special circumstances.

Although the present invention has been described with respect to a preferred embodiment thereof, those skilled in the art will note that various substitutions may be made to those embodiments described herein without departing from the spirit and scope of the present invention. The particular configuration functions specified and described herein have been selected for clarity of exposition, and do not represent all possible transformations. The stage at the auction process during which transformation functions are associated or bound with a bid or buyer or seller submitting the bid, or other entity as specified and described herein have been selected for clarity of exposition, and do not represent all possible auction stages when transformations could be associated or bound.

The manner in which transformation functions are associated with a bid or buyer or seller submitting the bid, or other entity, as specified and described herein have been selected for clarity of exposition, and do not represent all possible manners by which transformations could be associated or bound. Those skilled in the art will also note that although embodiments of the present invention have been described in the context of an auction or marketplace, certain features or embodiments may also apply to other forms of commerce and electronic commerce, including electronic negotiation, combinations of auctions and electronic negotiation, and various forms of interactions between and among various agents, including business entities, individuals, data processing systems, auctions, marketplaces, and intelligent software agents.

What is claimed is:

1. A method for facilitating the sale of an item, comprising:
receiving, from a participant, a request for an item;
identifying an auction for said item;
receiving, from said participant, a bid for said item; and
submitting said bid to said auction for said item.

2. The method of claim 1, further comprising:
identifying a transformation function associated with said participant; and
applying said transformation function to said bid to produce a transformed bid, wherein said bid submitted to said auction is a transformed bid.

3. The method of claim 2, further comprising:
updating a state of said auction based on said transformed bid.

4. The method of claim 3, further comprising:
receiving a status request from a second participant;
identifying a second transformation function associated with said second participant; and
applying said second transformation function to said status data to produce a transformed status.

5. The method of claim 4, wherein said status request is received via a second auction.

6. The method of claim 4, wherein said transformed status indicates at least one of: an amount which is different than an amount indicated by said status data; auction information which is identical to said status data; and auction information which is different than said status data.

7. The method of claim 2, wherein said transformation function is comprised of a plurality of intermediate transformations.

8. The method of claim 7, wherein each of said intermediate transformations are applied in a sequence.

9. The method of claim 1, wherein said receiving a request is performed by a first auction administrator, and wherein said auction for said item is conducted by a second auction administrator.

10. The method of claim 2, further comprising:
receiving at least a second bid for said item from a second participant;
comparing said second bid to said transformed bid to determine if said transformed bid or said second bid is the current best bid; and
updating a state of said auction to identify the current best bid.

11. The method of claim 2, wherein said transformation function includes at least one parameter whose value is determined based on data extrinsic to said auction.

12. The method of claim 1, wherein said auction is at least one of: an English auction, a Dutch auction, a Japanese auction, a sealed-bid auction, a double auction, a multiple-unit auction, a time interval auction, a call auction, a first price auction, a uniform second price auction, a bundle auction, a combinatorial auction, and a multi-attribute auction.

13. The method of claim 1, wherein said auction is a sell-side auction and wherein said bid is an offer to purchase.

14. The method of claim 1, wherein said auction is a buy-side auction and wherein said bid is an offer to sell.

15. The method of claim 1, wherein said auction is a two-sided auction and wherein said bid is at least one of an offer to buy or an offer to sell.

16. A method for operating a secondary auction, comprising:
receiving, from a participant, a request for an item;
identifying a primary auction offering said item;
receiving auction information from said primary auction;
presenting said auction information to said participant;
receiving, from said first participant, a bid on said item;
identifying at least a first transformation function associated with said first participant; and
applying said at least first transformation function to said bid to generate a transformed bid.

17. The method of claim 16, further comprising:
forwarding said transformed bid to said primary auction.

18. A method for operating a primary auction for an item, comprising:
receiving, from a secondary auction, a bid for said item, said bid having been transformed by at least one transformation function associated with an entity submitting said bid; and
updating a state of said primary auction based on said bid.

19. The method of claim 18, further comprising:
receiving, from a second secondary auction, a status request; and
forwarding information about said state of said primary auction to said secondary auction.

20. A method for participating in an auction involving a plurality of buyers and at least one seller of an item, comprising:
registering to participate as a buyer in said auction;
providing information about at least one characteristic, said characteristic at least one of a geographical characteristic, group characteristic and an industry characteristic; and
establishing at least a first transformation function for use in said auction based at least in part on said characteristic.

21. An exchange registration method, comprising:
receiving information identifying a buyer;
receiving information identifying a characteristic of said buyer, said characteristic at least one of a geographical characteristic and an industry characteristic; and
establishing, based at least in part on said information identifying said buyer and said characteristic, at least one transformation function for said buyer, said at least one transformation function for use in transforming bids made by said buyer in at least one exchange.

22. A method for facilitating the sale of an item in an auction, comprising:
identifying a first bid for said item, said bid made by a participant in a first marketplace;
identifying a second bid for said item, said bid made by a participant in a second marketplace;
identifying a transformation function associated with said first bid; and
applying said transformation function to said first bid to produce a transformed bid.

23. A method for facilitating the purchase of an item in an auction, comprising:
identifying a first offer for said item, said offer made by a participant in a first auction;
identifying a second offer for said item, said offer made by a participant in a second auction, where said second offer is a transformed offer based on at least a first characteristic identified in said first auction; and
comparing said first offer and said second offer to identify a best bid.

24. An auction method, comprising:
identifying a bid for a first item from a first auction;
identifying a bid for a second item from a second auction;
identifying a common characteristic of said first and second items; and
conducting an auction for said first and second items based on said common characteristic.

25. The method of claim 24, wherein said common characteristic is at least one of an industry characteristic a geographic characteristic and a group characteristic.

26. A method of composing a plurality of auctions comprising:
identifying a first bid from a first auction, said first bid transformed by at least a first transformation function;
identifying a second bid from a second auction, said second bid transformed by at least a second transformation function; and
comparing said first and second bids to identify a best bid.

27. An auction apparatus, comprising:
means for receiving, from a participant, a request for an item;
means for identifying an auction for said item;
means for receiving, from said participant, a bid for said item;
means for identifying a transformation function associated with said participant; and
means for applying said transformation function to said bid to produce a transformed bid.

28. An apparatus for facilitating the sale of an item in an auction involving a plurality of participants, comprising:
a processor;
a communications device in communication with said processor, receiving a request for an item from one of said participants, and
a memory unit in communication with said processor and storing a program, wherein the processor is operative with said program to
identify an auction for said item;
receive, from said participant, a bid for said item;
identify a transformation function associated with said participant; and
apply said transformation function to said bid to produce a transformed bid.

29. A computer-readable medium having computer-executable instructions for performing steps comprising:
(a) receiving, from a participant in a first auction, a request for an item;
(b) identifying an auction for said item, said auction different than said first auction;
(c) receiving, from said participant, a bid for said item; and
(d) submitting said bid to said auction for said item.

30. A computer-readable medium having computer-executable instructions for performing steps comprising:
(a) identifying a first bid from a first auction, said first bid transformed by at least a first transformation function;
(b) identifying a second bid from a second auction, said second bid transformed by at least a second transformation function; and
(c) comparing said first and second bids to identify a best bid.

31. An auction system, comprising:
a first auction administrator device conducting a first auction;
a participant device, said participant device in communication with said first auction administrator device to submit a bid on an item, said first auction administrator device operable to identify at least a second auction offering said item and forwarding said bid to said at least second auction.

32. The auction system of claim 31, wherein said first auction administrator device is further operable to apply at least a first transformation function to said bid to generate a transformed bid and wherein said transformed bid is forwarded to said at least second auction.

33. An auction system, comprising:
means for identifying a bid for a first item from a first auction;
means for identifying a bid for a second item from a second auction;
means for identifying a common characteristic of said first and second items; and
means for conducting an auction for said first and second items based on said common characteristic.
